(19) United States
(12) Patent Application Publication
(10) Pub. No.: US 2026/0309965 A1
(43) Pub. Date: Oct. 8, 2026

(54) SYSTEM AND METHOD FOR MICROSCOPY USING A SMART DEVICE

(71) Applicant: Georgia Tech Research Corporation, Atlanta, GA (US)

(72) Inventors: Alexander T. Adams, Atlanta, GA (US); Kefan Song, Atlanta, GA (US)

(73) Assignee: Georgia Tech Research Corporation, Atlanta, GA (US)

(21) Appl. No.: 19/638,385

(22) Filed: Apr. 3, 2026

Related U.S. Application Data
(60) Provisional application No. 63/783,398, filed on Apr. 4, 2025.

(51) Int. Cl. G02B 21/00; G02B 21/34; G02B 21/36

(52) U.S. Cl. CPC G02B 21/0008; G02B 21/0028; G02B 21/0032; G02B 21/361; G02B 21/365; G02B 21/34

(57) ABSTRACT

A system for microscopy includes an attachment housing removably mounted to a smart device. The attachment housing includes a lighting system and an optical system, while the smart device includes a camera light and a camera. The lighting system is operably connected to the camera light for illuminating a slide held within the attachment housing, while the optical system is operably connected to the camera for imaging the slide. Once the slide has been imaged, image may be processed to obtain information on the biological specimen on the slide.

### CROSS-REFERENCE TO RELATED APPLICATIONS

This application claims the benefit of prior-filed, co-pending U.S. Provisional Patent Application No. 63/783,398, filed on Apr. 4, 2025, the contents of which are incorporated herein by reference in their entirety.

### BACKGROUND

The present application is directed to the field of laboratory equipment. More specifically, the present application is directed to the field of medical microscopy using a smart device.

Clinical lab tests are part of the standardized preoperative exam guidelines observed in healthcare systems in the world. When testing is required preoperatively, blood tests are almost always performed since they are able to help assess a patient's general health condition, evaluate organ function, identify bleeding disorders, as well as determine infection or inflammatory conditions. Urine sample analysis is also commonly ordered, especially for patients with urinary tract symptoms or undergoing urological procedures. A great deal of information could be extracted from these tests, but most of this information involves the presence or concentration of certain cells or chemicals, such as full blood count, creatinine concentration, and hematuria.

Research studies have indicated that many routine preoperative tests are excessive and their results would not alter the surgical outcome. However, current clinical guidelines still suggest the inclusion of such tests based on the historical findings and patient conditions. In modern practice, risk stratification algorithms are often used to determine which preoperative tests are required, based on a patient's medical history, comorbidities, and the complexity of the procedure. While these algorithms help optimize patient care, they can also lead to a large number of tests, especially for high-risk patients. Performing this extensive testing often requires significant time and resources, contributing to delays in the preoperative process. The debate over whether to cut certain tests is ongoing, but a more practical solution would be to make these tests cheaper and easier to perform to reduce required time and resources without compromising patient safety.

Many individuals seeking high-quality medical care travel significant distances to reach advanced medical facilities, far from their residences. They also face excess travel frequency for unnecessary preoperative testing, no matter how near or far they live from hospitals. Even in a well-developed country like the United States, this phenomenon is still notably prevalent, where more than 50% of patients received unindicated preoperative tests, and about a quarter of patients traveled more than 100 miles to receive congenital heart surgery. This distance poses substantial challenges, including transportation difficulties and the timely collection and examination of samples. Scheduling preoperative exams becomes particularly tricky because these tests are usually conducted shortly before the surgery. Backlogs at testing facilities and delays in obtaining test results have been shown to contribute to the postponement of elective surgeries. Additionally, involving a third-party medical facility nearby for preoperative testing only is not always feasible due to logistical issues and the need for careful appointment planning.

In rural settings, the infrastructure might not support the timely transportation of samples to distant labs, potentially delaying diagnosis and treatment. This problem is compounded by the fact that many rural areas have limited access to specialized medical equipment and trained personnel, further hindering the efficiency of preoperative testing.

Moreover, the current lab test procedures require sending samples to specific labs where complicated processing steps are involved, resulting in delays in obtaining results. It also raises the issue of the availability of such labs, especially in underdeveloped areas. In other countries around the world, there is a significant shortage of both pathological lab equipment as well as personnel, which exacerbates the problem. This shortage means that many patients in remote or under-served regions may not have timely access to necessary preoperative tests, leading to delays in surgical procedures and potentially compromising patient outcomes. Additionally, the overburdened existing labs often struggle to keep up with the demand, leading to further delays and a backlog of tests.

This situation underscores the urgent need for more efficient and accessible diagnostic solutions that can deliver accurate results quickly and reliably, without being dependent on centralized lab facilities. To address these challenges, there is a growing need for diagnostic solutions that do not rely on fully equipped laboratories or specialized personnel. Instead, these solutions aim to bring testing directly to the point of care, allowing for faster and more convenient testing without the need for large-scale infrastructure.

On the other hand, point-of-care (POC) devices have gained popularity and might offer a viable alternative to traditional clinical lab testing, as they can potentially streamline the testing process, providing results more quickly and efficiently. POC devices are designed to perform a variety of tests at or near the site of patient care, thereby reducing the need for sample transport and expediting the diagnostic process. The development of POC devices has also benefited from the fast advancement and widespread adoption of smart device technologies, as the high data processing capabilities and powerful sensors of smart devices such as smartphones and tablets can be utilized for POC devices, thus eliminating hurdles in both cost and access to high-end technology. This is especially important in rural areas because even though their access to healthcare facilities and laboratories is the most limited, their ownership rate of smart devices is comparable to that of urban areas, at about 80%.

The advancement of POC technology has the potential to revolutionize preoperative testing. These devices are compact, easy to use, and can deliver accurate results rapidly, making them ideal for use in both rural and urban settings. The convenience and speed offered by POC testing can also facilitate more effective preoperative assessments, reducing the time patients spend waiting for test results and enabling quicker surgical interventions. Furthermore, POC devices integrated into smart devices can be designed to be user-friendly and mostly automatic, allowing patients with minimal training to perform complex diagnostic tests easily and accurately from their homes.

The need for smart device-based POC devices extends beyond just convenience. The ability of the smart device to provide and transmit timely data and rapid analysis of the collected sample allows for the full utilization of the professional pathologist network worldwide, so experts around the world could help guide sample collection procedures or review analysis results to eliminate patient constraints of local resource availability and accessibility.

There is an unmet need for a POC microscopy system for a smart device that can perform lab tests accurately with a uniform testing scale, without being cost-prohibitive or logistically challenging.

### BRIEF DESCRIPTION OF THE SEVERAL VIEWS OF THE DRAWINGS

FIG. 1a illustrates an example of a system for microscopy using a smart device according to certain embodiments.

FIG. 1b illustrates an example of an optical system used in the system according to certain embodiments.

FIG. 1c illustrates examples of an attachment housing used in the system according to various embodiments.

FIG. 1d illustrates an example of an alternate slide holder used in the system according to certain embodiments.

FIGS. 2a, 2b, and 2c illustrate a flowchart of an example of a method for using a system for microscopy according to certain embodiments.

FIG. 3 illustrates an example of a user interface for the smart device of the system for microscopy according to certain embodiments.

It should be understood that, for clarity, not all elements are labeled in all drawings. Lack of labeling in a figure should not be interpreted as lack of a feature.

### SUMMARY

The system for microscopy comprises an attachment housing removably mounted to a smart device. The attachment housing comprises a lighting system and an optical system, while the smart device comprises a camera light and a camera. The lighting system is operably connected to the camera light for illuminating a slide held within the attachment housing. The optical system is operably connected to the camera for imaging the slide.

A method for using the above system includes placing a slide having a prepared biological sample in the system, receiving a value to set a camera's sensitivity to light, receiving an exposure value to set the camera's shutter time, activating a camera light, capturing an image of the biological sample with the camera, and loading the image taken with the camera into an image processing environment. The image processing may include cropping the image to exclude dark areas, converting the image to grayscale, isolating a field-of-view (FOV) area, and enhancing cell boundaries in the FOV area. Further image analysis may include applying a noise reduction filter, applying a sharpening filter to enhance edges of cells in the FOV area, applying a filter to reduce noise while preserving edges of cells in the FOV area, enhancing local contrast in the FOV area, adjusting brightness and fine-tuning contrast to improve visibility of cells in the FOV area, and identifying targeted cell types in the FOV area.

The objects and advantages of the invention will appear more fully from the following detailed description of the embodiments of the invention and examples.

### DETAILED DESCRIPTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Dimensions and materials identified in the drawings and applications are by way of example only and are not intended to limit the scope of the claimed invention. Any other dimensions and materials not consistent with the purpose of the present application can also be used. Various equivalents, alternatives and modifications are possible within the scope of the appended claims. Each limitation in the appended claims is intended to invoke interpretation under 35 U.S.C. § 112, sixth paragraph, only if the terms “means for” or “step for” are explicitly recited in the respective limitation.

### System

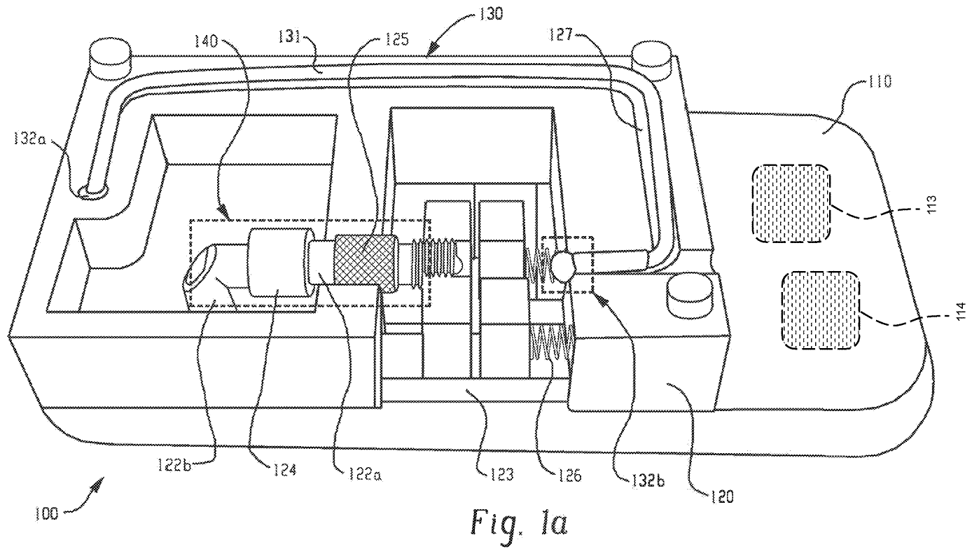

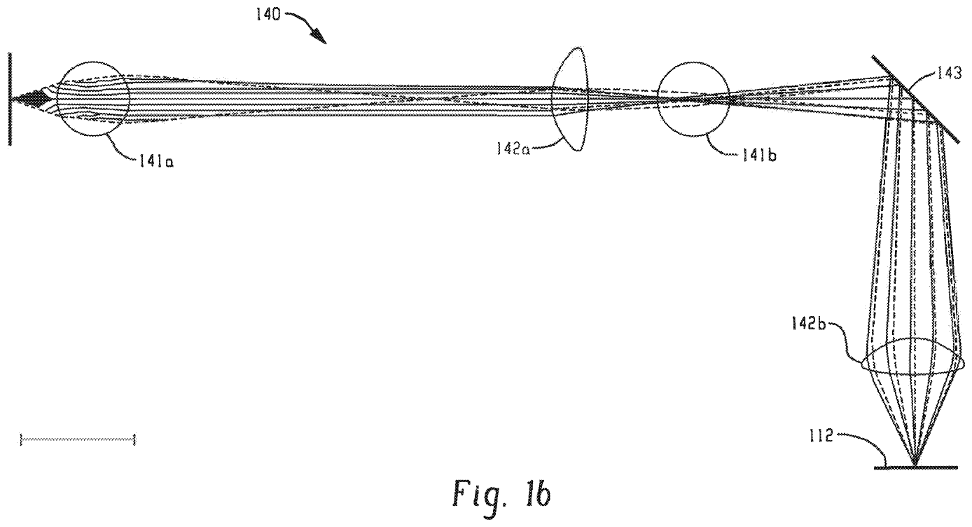

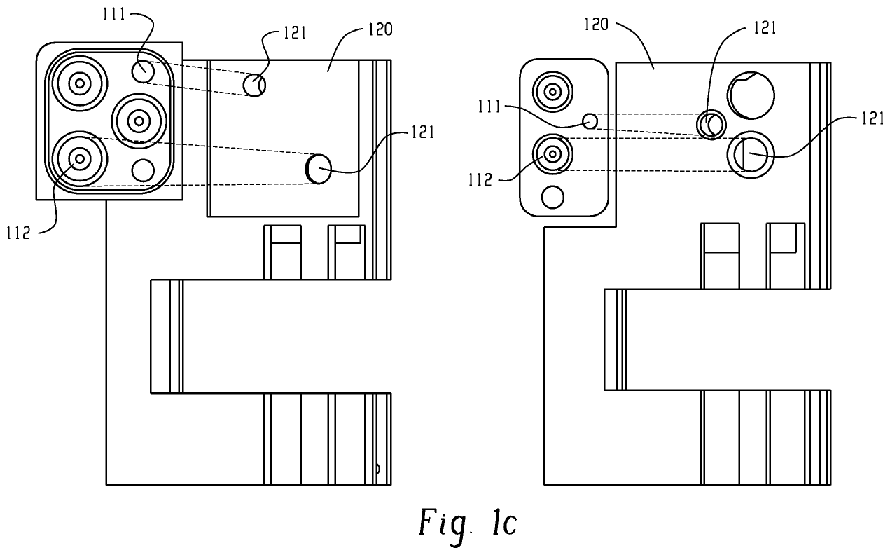

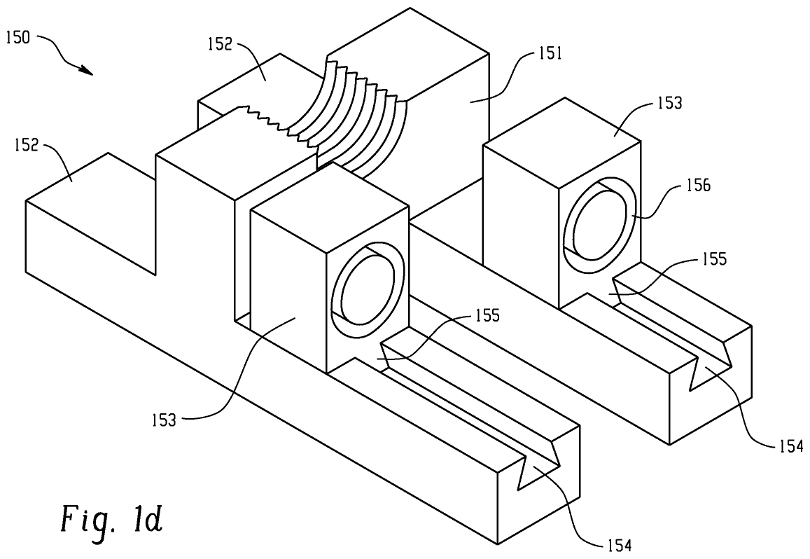

FIG. 1a illustrates an example of a system 100 for microscopy using a smart device 110 according to certain embodiments. FIG. 1b illustrates an example of an optical system 140 used in the system 100 according to certain embodiments. FIG. 1c illustrates examples of an attachment housing 120 used in the system 100 according to various embodiments. FIG. 1d illustrates an example of an alternate slide holder 150 used in the system 100 according to certain embodiments.

Referring to FIG. 1a, in an embodiment, the present system 100 includes at least one smart device 110 to which is removably mounted the attachment housing 120. The attachment housing 120 includes a lighting system 130 for illuminating a slide (not shown) using a camera light 111 of the smart device 110, as well as a slide holder 150. The attachment housing 120 also includes an optical system 140 for imaging the slide using a camera 112 of the smart device 110.

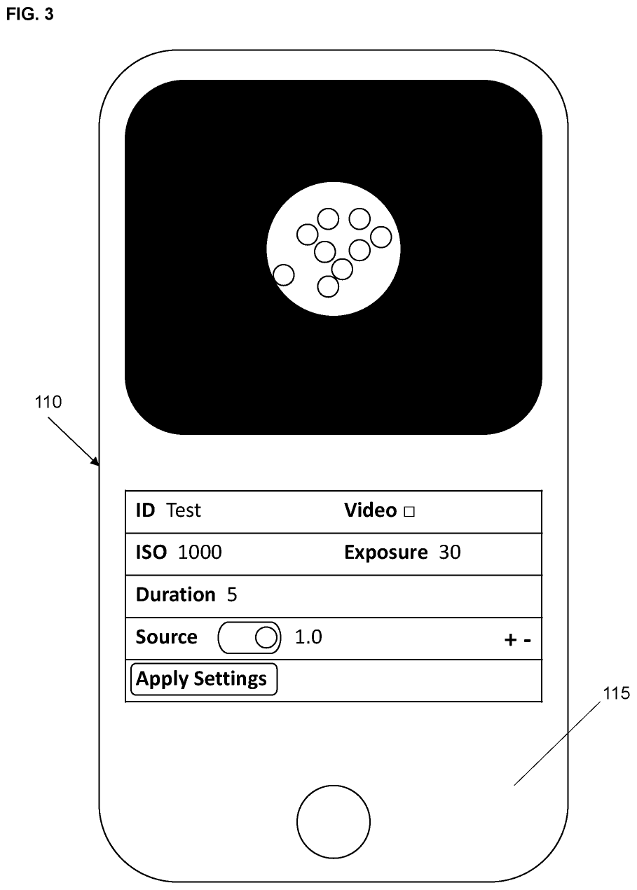

The smart device 110 includes at least one camera light 111 generally used in photographic applications with the camera 112. The camera 112 is a typical smart device camera known in the art. The smart device 110 also includes at least one processor component 113 for controlling the microscopy system 100 and processing the resultant image. The smart device 110 also includes at least one storage component 114 for storing data obtained by the camera 112 or by processing or user input. The smart device 110 also includes at least one user interface 115, as seen in FIG. 3, for receiving user input and commands, and displaying data or images obtained by the camera 112 or by processing. In the embodiment shown in FIG. 1a, the smart device is a smart phone. Other embodiments may use a tablet, pad, or other smart device.

The attachment housing 120 is removably attached to the smart device 110. The attachment housing 120 may be a polymer housing and may be 3D printed or molded. Referring to FIG. 1c, the attachment housing 120 includes at least one housing aperture 121 allowing access to the camera light 111. In various embodiments, the same housing aperture 121 or a different housing aperture 121 also allows a clear view from the camera 112 to an at least partially angled optical barrel 122b and a straight optical barrel 122a containing the optical system 140. The location of the housing aperture(s) 121 corresponds to the placement of the camera light 111 and camera 112 on the brand and model of smart device 110 used to ensure proper alignment of the housing aperture(s) 121. The size and dimensions of the attachment housing 120 will also correspond to the brand and model of smart device 110 used.

Referring to FIG. 1a, the angled and straight optical barrels 122b and 122a extend in two parts; the angled optical barrel 122b extends between the housing aperture 121 over the camera 112 and a spacer 124, while the straight optical barrel 122a extends between the spacer 124 and a slide holder 123. The spacer 124 is connected to the attachment housing 120 and keeps the angled and straight optical barrels 122b and 122a at a fixed distance for optimal image focus.

A distal end of the straight optical barrel 122a is rotatably connected to slide holder 123 by external threading corresponding to internal threading in the slide holder 123. A grip 125 extending around the outer surface of the straight optical barrel 122a allows easy gripping and rotation of the straight optical barrel 122a. Rotation of the grip 125 and straight optical barrel 122a will therefore cause the slide holder 123 to displace position towards or from the distal end of the straight optical barrel 122a. This displacement may adjust focus on a slide (not shown) held in the slide holder 123.

At least one biasing spring 126 extends between a side of the slide holder 123 opposite the straight optical barrel 122a and the attachment housing 120. The biasing spring 126 biases the slide holder 123 toward the spacer 124 and ensures that the slide holder 123 maintains position. The biasing spring may be a helical compression spring, torsion spring, leaf spring, or any other type or combination of biasing spring known in the art.

A light channel 127 is configured as a groove extending along the attachment housing 120 between the camera light 111 and the side of the slide holder 123 opposite the optical barrel 122. The light channel 127 holds components of the lighting system 130 in place. A housing lid (not shown) may cover the components within the attachment housing 120 except for the slide holder 123, spacer 124, and grip 125.

The lighting system 130 includes a light pipe 131 extending between a pair of light ball lenses 132a and 132b. The light pipe 131 transmits and directs light emitted by the camera light 111 to backlight the slide. In an embodiment, a beam of light emitted by the camera light 111 extends through the light pipe 131 to the slide holder 123 to backlight the slide. In various embodiments, the light pipe 131 may comprise any number or combination of rods or fibers of glass or polymer which are flexible or rigid and capable of transmitting light. The first light ball lens 132a adjacent to the camera light 111 is able to collect emitted light from the camera light 111 into a first end of the light pipe 131. The second light ball lens 132b on the other end of the light pipe 131 is able to focus more light onto the slide. This brighter illumination significantly enhances the visibility of cells in captured images, thereby providing more detailed morphological information about the cells, and improving the accuracy and reliability of a cell counting process.

As shown in FIG. 1b, the optical system 140 comprises a series of optical ball lenses 141a and 141b, aspherical lenses 142a and 142b, and a mirror 143. A first optical ball lens 141a is at the distal end of the straight optical barrel 122a adjacent to the slide. Following in series are a first aspherical lens 142a, a second optical ball lens 141b, and the mirror 143. The mirror 143 is angled at a 45 degree angle to redirect the light received into a second aspherical lens 142b adjacent to the camera 112. In the embodiment shown in FIGS. 1a and 1b, the straight optical barrel 122a contains the first optical ball lens 141a and the first aspherical lens 142a, while the angled optical barrel 122b contains the second optical ball lens 141b, the mirror 143, and the second aspherical lens 142b. The angled mirror 143 enables the majority of the optical system 140 to lay parallel to the smart device 110 to make the system 100 more compact. In an embodiment, the optical ball lenses 141a and 141b are 4 mm diameter quartz ball lenses. In an embodiment, the aspherical lenses 142a and 142b are 5 mm outer diameter acrylic aspherical lenses. The first optical ball lens 141a was chosen due to its high magnification ratio, but since this also introduces a large number of aberrations, the image is immediately corrected with the first aspherical lens 142a. This combination is then replicated with the second optical ball lens 141b and second aspherical lens 142b to achieve the desired magnification level.

In the embodiment shown in FIG. 1a, the slide holder is a single H-shaped block, slidable within the attachment housing 120 and having a slot for inserting the slide. In another embodiment shown in FIG. 1d, the slide holder 150 is not a unitary block, but has interlocking movable parts to allow the slide to be actively fixed into place. A slide anvil 151 is connected to at least one slide rail 152. The slide anvil 151 is located adjacent to the optical system 140, and includes the same internal threading as the earlier embodiment. At least one slide clamp 153 is capable of travelling along the slide rail 152, biased by at least one biasing spring 126. The slide clamp 153 includes a slide projection 155 extending outwardly to be received by a slide groove 154 in the slide rail 152. Other embodiments may reverse this configuration with a slide groove 154 in the slide clamp 153 and a slide projection 155 extending from the slide rail 152. The combination of the slide projection 155 and slide groove 154 may be configured to allow sliding along the longitudinal axis of the slide rail 152 but prevent disconnection of the components along axes orthogonal to the longitudinal axis of the slide rail 152. The slide clamp 153 may also include at least one spring groove 156 to receive one end of the biasing spring 126. The embodiment shown in FIG. 1d includes two slide rails 152 interconnected by the slide anvil 151, with two slide clamps 153.

It should be appreciated that elements of any embodiment may be combined with elements of any other embodiment.

### Method

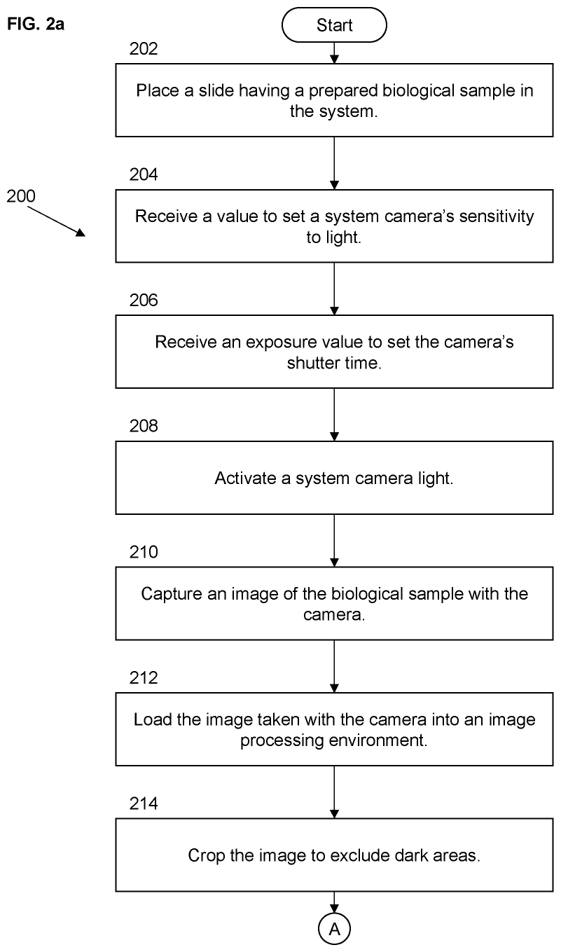

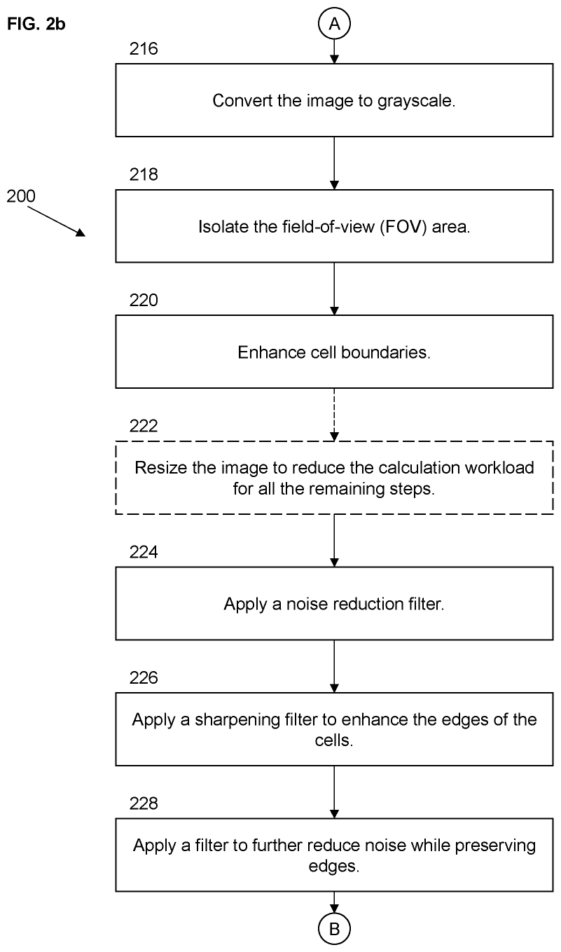

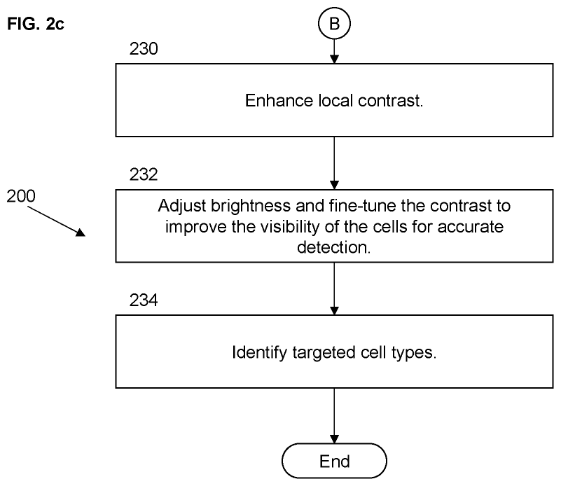

FIGS. 2a through 2c depict a flowchart of an example of a method 200 for using a microscopy system 100 according to certain embodiments. Blocks 202 through 208 comprise an initial setup of the system 100. Adjusting these settings helps optimize image quality based on the smart device model and the type of analysis required. Blocks 212 through 222 comprise use of the microscopy system 100 to process the raw image. Blocks 224 through 236 comprise use of the microscopy system 100 to analyze the processed image. The numbering and sequencing of the blocks are for reference only; blocks or sequences of blocks may be performed out of order or repeated.

In block 202, a user places a slide having a prepared biological sample in the system.

In block 204, the system receives a value to set a system camera's sensitivity to light. In an embodiment, the system receives an International Organization for Standardization (ISO) value.

In block 206, the system receives an exposure value to set the camera's shutter time.

In block 208, the system activates a system camera light. Due to the placement of a lighting system within the system, this backlights the slide.

In block 210, the system captures an image of the biological sample with the camera.

In block 212, the system loads the image taken with the camera into an image processing environment.

In block 214, the system crops the image to exclude dark areas. In an embodiment, the system crops the image to a square shape.

In block 216, the system converts the image to grayscale.

In block 218, the system isolates the field-of-view (FOV) area. The FOV area will be used for further image processing and analysis. In an embodiment, the system applies a circular mask to the image to isolate the FOV area.

In block 220, the system enhances cell boundaries. In various embodiments, the system enhances the boundaries with min-max normalization, histogram equalization, z-score normalization, gamma correction, or any combination thereof. In an embodiment, the system enhances based on the pixel intensities in the FOV area.

In optional block 222, the system resizes the image to reduce the calculation workload for all the remaining steps. In an embodiment, the image is shrunken to a dimension of 501 by 501 pixels.

In block 224, the system applies a noise reduction filter. In various embodiments, the system may apply a Gaussian filter, bilateral filter, non-local means filter, total variation denoising filter, or any combination thereof. In an embodiment, the system applies a filter with a kernel size of 5×5. This filtration reduces noise and optimizes image quality for subsequent processing.

In block 226, the system applies a sharpening filter to enhance the edges of the cells. In various embodiments, the system applies high-boost filtering, Laplacian-based sharpening, adaptive sharpening methods, or any combination thereof. In an embodiment, the sharpening filter used the following 3×3 kernel:

$$[ \begin{matrix}- 1 & - 1 & - 1 \\ - 1 & 9 & - 1 \\ - 1 & - 1 & - 1\end{matrix} ]$$

In block 228, the system applies a filter to further reduce noise while preserving edges. In various embodiments, the system applies an adaptive median filter, a weighted median filter, a standard median filter that applies the same filter globally, an alpha-trimmed mean filter, or any combination thereof. In an embodiment, the median filter applies a 5×5 window.

In block 230, the system enhances local contrast. In various embodiments, the system applies a contrast limited adaptive histogram equalization (CLAHE), adaptive histogram equalization (AHE), multi-scale Retinex (MSR), adaptive gamma correction, local contrast normalization, or any combination thereof. In an embodiment, the CLAHE uses a clip limit of 1.0 and a grid size of 8×8.

In block 234, the system adjusts brightness and fine-tunes the contrast to improve the visibility of the cells for accurate detection. In various embodiments, the system utilizes computer vision approaches such as, but not limited to, template matching, or contour detection. In various embodiments, the system utilizes machine learning approaches such as, but not limited to, a k-nearest neighbor (kNN) algorithm or a support vector machine (SVM). In various embodiments, the system utilizes deep learning approaches such as, but not limited to, a convolutional neural network (CNN), and a transformer. In various embodiments, the system utilizes any combination of the above approaches. In an embodiment, the brightness is adjusted by adding a constant bias of 7, and the contrast is fine-tuned with a scaling factor of 1.02.

In block 236, the system identifies targeted cell types. In an embodiment, the system uses a Hough circle algorithm to identify targeted cell types. The targeted cell is identified by its minimal and maximal diameter in number of pixels, as well as the minimum distance between cells. These dimensions can be looked up in units of micrometers and converted to the number of pixels based on the pixel resolution of the image. In an embodiment, the system uses a minimum radius of 2.5 mm and a maximum radius of 5 mm. In an embodiment, the minimum distance between circles is set to 4.5 mm to reduce the false detection of multiple neighboring circles in addition to the true one. In an embodiment, the conversion ratio is calculated using a fixed spacing grid target.

In an embodiment, blocks 212 through 222 take place in a Python environment with OpenCV. In an embodiment, blocks 224 through 236 take place in a Matlab environment.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems, and method steps. It is to be expected that various equivalents, alternatives, and modifications are possible within the scope of the foregoing description.

What is claimed is:

1. A system for microscopy, comprising:
an attachment housing removably mounted to a smart device,
wherein the attachment housing comprises a lighting system and an optical system,
wherein the smart device comprises a camera light and a camera,
wherein the lighting system is operably connected to the camera light for illuminating a slide held within the attachment housing, and
wherein the optical system is operably connected to the camera for imaging the slide.

2. The system of claim 1,
wherein the attachment housing further comprises a straight optical barrel and an angled optical barrel extending between at least one housing aperture and a slide holder,
wherein the straight optical barrel and the angled optical barrel contain the optical system, and
wherein the angled optical barrel is at least partially angled.

3. The system of claim 2, wherein the at least one housing aperture allowing access to the camera light and a clear view from the camera to the angled optical barrel.

4. The system of claim 2, wherein a distal end of the straight optical barrel is rotatably connected to the slide holder.

5. The system of claim 4, wherein the straight optical barrel has external threading corresponding to internal threading in the slide holder.

6. The system of claim 5, wherein rotation of a grip mounted to an outer surface of the straight optical barrel rotates the straight optical barrel, causing the slide holder to displace position towards or from the distal end of the straight optical barrel.

7. The system of claim 2, wherein the attachment housing further comprises a spacer connecting a proximal end of the straight optical barrel and a distal end of the angled optical barrel.

8. The system of claim 2, wherein at least one biasing spring extends between a side of the slide holder opposite the optical barrel and the attachment housing.

9. The system of claim 8, wherein the at least one biasing spring biases the slide holder toward the optical barrel.

10. The system of claim 2, wherein the attachment housing further comprises a light channel extending between the camera light and a side of the slide holder opposite the optical barrel.

11. The system of claim 2, wherein the optical system comprises in series a first optical ball lens adjacent to the slide, a first aspherical lens, second optical ball lens, a mirror, and a second aspherical lens adjacent to the camera.

12. The system of claim 11, wherein the mirror is angled at a 45 degree angle.

13. The system of claim 11, wherein the first optical ball lens and the first aspherical lens are located in the straight optical barrel, and the second optical ball lens, the mirror, and the second aspherical lens are located in the angled optical barrel.

14. The system of claim 11, wherein the first and second optical ball lenses are 4 mm diameter quartz ball lenses and the first and second aspherical lenses are 5 mm outer diameter acrylic aspherical lenses.

15. The system of claim 1, wherein the lighting system comprises a light pipe extending between a pair of light ball lenses.

16. The system of claim 15, wherein a beam of light emitted by the camera light extends through the light pipe to the slide holder to backlight the slide.

17. A method for using a system for microscopy, comprising:
placing a slide having a prepared biological sample in the system;
receiving a value to set a camera's sensitivity to light;
receiving an exposure value to set the camera's shutter time;
activating a camera light;
capturing an image of the biological sample with the camera;
loading the image taken with the camera into an image processing environment;
cropping the image to exclude dark areas;
converting the image to grayscale;
isolating a field-of-view (FOV) area;
enhancing cell boundaries in the FOV area;
applying a noise reduction filter;
applying a sharpening filter to enhance edges of cells in the FOV area;
applying a filter to reduce noise while preserving edges of cells in the FOV area;
enhancing local contrast in the FOV area;
adjusting brightness and fine-tuning contrast to improve visibility of cells in the FOV area; and
identifying targeted cell types in the FOV area.

18. The method of claim 17, wherein applying a noise reduction filter comprises applying a Gaussian filter.

19. The method of claim 17, wherein identifying targeted cell types comprises using a Hough circle algorithm to identify targeted cell types.

20. The method of claim 17, further comprising resizing the image to reduce calculation workload.
